(19) United States
(12) Patent Application Publication
(10) Pub. No.: US 2012/0136501 A1
(43) Pub. Date: May 31, 2012

(54) COMPUTER CHASSIS SYSTEM

(75) Inventors: Hsing-Chao GAU, TAIPEI CITY (TW); Huang-Ching WANG, TAIPEI CITY (TW); Chien-Chuan HUANG, TAIPEI CITY (TW)

(73) Assignee: INVENTEC CORPORATION, TAIPEI CITY (TW)

(21) Appl. No.: 12/981,482

(22) Filed: Dec. 30, 2010

(30) Foreign Application Priority Data
Nov. 30, 2010 (TW) 099141485

(51) Int. Cl. G05B 15/02; G05D 23/19

(52) U.S. Cl. 700/300; 700/11

(57) ABSTRACT

A computer system contains motherboards, chassis management board and functional components. The motherboards have a micro control unit, and the functional components are electrically connected to the chassis management board, in which the micro control unit processes the data and passes the processed data to the chassis management board through a transmission line. The chassis management board receives and decodes the information from the micro control unit, then the chassis management board transmits the decoded information to the functional elements. The chassis management board also receives and passes the information returned from the functional components to the micro control unit through the transmission line.

### RELATED APPLICATIONS

This application claims priority to Taiwan Application Serial Number 099141485, filed Nov. 30, 2010, which is herein incorporated by reference.

### BACKGROUND

1. Field of Invention

The present invention relates to a computer system. More particularly, the present invention relates to a computer system having multiple circuit boards.

2. Description of Related Art

With the fast changing of the electronic technology, the assembling of an electronic device such as a computer, a server and so on, becomes more and more precise. It is already an understandable focus in the industry how to improve a work efficiency to meet a maximum economic benefit. Taking a server as an example, in addition to a motherboard, the server has a storage device for storing mass data, such as a hard disk driver, a floppy disk driver and an optical disc driver used for reading external data, etc. Compared with a common desktop computer, the server has the advantages of a high-speed computation, a long-time reliable computation and a strong ability to input and output external data.

Such a server includes plural motherboards therein, wherein each of the motherboards has a baseboard management controller (BMC) with a relatively simple function and other circuits. However, the baseboard management controller has a prohibitive cost and the plural motherboards require plural baseboard management controllers, thus greatly increasing a manufacturing cost. Moreover, the baseboard management controllers need to be connected to each functional component through complex circuits and switching circuits. The complex circuits consume a huge amount of manpower and a high-density circuit may impair a signal transmission.

Therefore, it is necessary to provide a novel computer system capable of simplifying a connection manner of multiple motherboards of a server, avoiding an excessive complexity of a circuit and saving the manpower for wiring.

### SUMMARY

Accordingly, an aspect of the present invention provides a computer system, which is capable of simplifying a circuit connection within the system, avoiding an overhigh density or excessive complexity of a circuit within the system so as not to cause a short circuit or an electromagnetic interference, and reducing the manpower for wiring.

According to an embodiment of the present invention, the computer system integrates and simplifies a plurality of circuits. The computer system includes at least one motherboard, a chassis management board, and at least one functional component. The motherboard has a micro control unit, and the functional component is electrically connected to the chassis management board. The micro control unit processes a data and passes the processed data to the chassis management board through a transmission line. After receiving and decoding the data passed from the micro control unit, the chassis management board transmits the data to the functional component, and after receiving the data returned from the functional component, the chassis management board processes the data and passes it to the micro control unit through the transmission line.

The computer system in the above embodiment a micro control unit substitutes a baseboard management controller on each motherboard. Thus, the computer system is capable of reducing a manufacturing cost, simplifying a circuit connection within the system, avoiding an overhigh density or excessive complexity of a circuit within the system so as not to cause a short circuit or an electromagnetic interference, and reducing the manpower for wiring.

### BRIEF DESCRIPTION OF THE DRAWINGS

In order to make the foregoing as well as other aspects, features, advantages, and embodiments of the present invention more apparent, the accompanying drawings are described as follows:

FIG. 1 is a block diagram of a computer system according to an embodiment of the present invention; and

FIG. 2 is a block diagram of a computer system according to another embodiment of the present invention.

### DETAILED DESCRIPTION

In the following embodiments of the computer system according to the present invention, micro control units substitute most of the baseboard management controllers, thereby reducing a manufacturing cost thereof. In addition, the computer system uses a chassis management board to integrate signals that are transmitted by motherboards to functional components (e.g. the hard disk backplane, the sensor, the power module, the fan module and so on), thereby simplifying the circuit connections within the system, avoiding an overhigh density or excessive complexity of a circuit within the system so as not to cause a short circuit or an electromagnetic interference, and reducing the manpower for wiring.

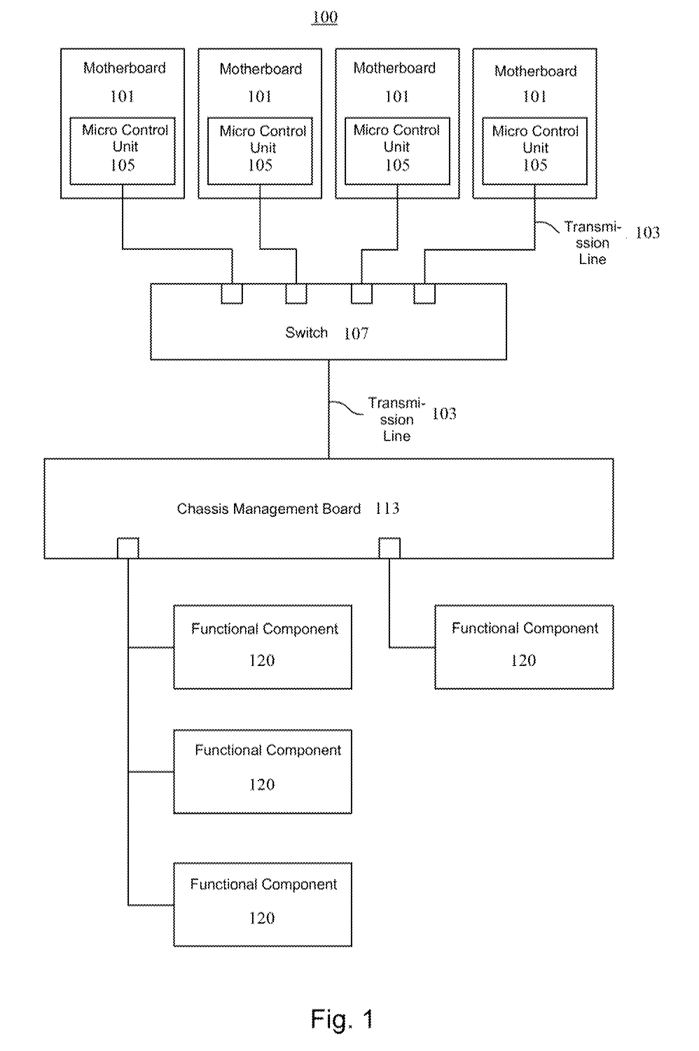

Referring to FIG. 1, FIG. 1 is a block diagram of a computer system according to an embodiment of the present invention. The computer system 100 can integrate and simplify multiple circuits. The computer system 100 includes a motherboard 101, a switch 107 and a chassis management board 113.

The motherboard 101 has a micro control unit 105. The micro control unit 105 processes an instruction and data that are to be sent by the motherboard 101, and passes the processed instruction and data externally through a transmission line 103. The motherboard 101 is no longer equipped with a baseboard management controller, thereby reducing a manufacturing cost, and the motherboard 101 no longer directly communicates with a functional component 120 through the circuits, thereby greatly simplifying circuit connections.

After receiving the data passed by the transmission line 103, the switch 107 transmits the data to the chassis management board 113, and after decoding the received data, the chassis management board 113 transmits the decoded data to the corresponding functional component 120. The transmission line 103 may be a network line. In this case, the micro control unit 105 passes the data that is to be sent by the motherboard 101 after encapsulating the data into a network packet. The chassis management board 113 decodes the network packet into signals which can be received by the functional component 120 and then transmits the signals to the corresponding functional component 120. When the functional component 120 returns any data, the chassis management board 113 encapsulates the data into network packets and sends the network packets to the switch 107, and then the switch 107 passes the network packets to the micro control unit 105 on the corresponding motherboard 101, so as to decode the data. The switch 107 can also be integrated into the chassis management board 113. That is, the micro control unit 105 is electrically connected to the chassis management board 113 directly. In addition, when receiving the data returned from the functional component 120, the chassis management board 113 passes the data directly to the corresponding micro control unit 105 after processing.

More specifically, the motherboard 101 no longer passes the instruction and the data by itself, but the instruction and the data after being integrated are passed via the switch 107 and the chassis management board 113. In this way, as for the circuits on the computer system 100, especially on the motherboard 101 which may originally need up to 25 circuits, the motherboard 101 now needs to be connected with the chassis management board 113 through only one transmission line 103. Thus, the circuits can be effectively simplified.

In order to be connected with various functional components 120, the chassis management board 113 may include a Keyboard Controller Style (KCS) interface, an Inter-Integrated Circuit (12C) interface, a Universal Asynchronous Receiver/Transmitter (UART) interface, a Serial Peripheral Interface (SPI), a General Purpose I/O (GPIO) interface, a Universal Serial Bus (USB) interface or a Local Area Network (LAN) interface. The chassis management board 113 is responsible for collecting information on each motherboard 101 and monitoring and managing electronic devices on the computer system 100 according to a received instruction and data. After the micro control unit 105 substitutes for a baseboard management controller, a task which is originally performed by the baseboard management controller on each motherboard 101, is now performed by the chassis management board 113 instead, such as allocating power for motherboards, monitoring and recording whether a temperature data of the computer system 100 is beyond a standard, or monitoring various transmission errors so that a monitoring operator can conveniently manage and maintain the computer system 100 or can provide data for improving the computer system 100.

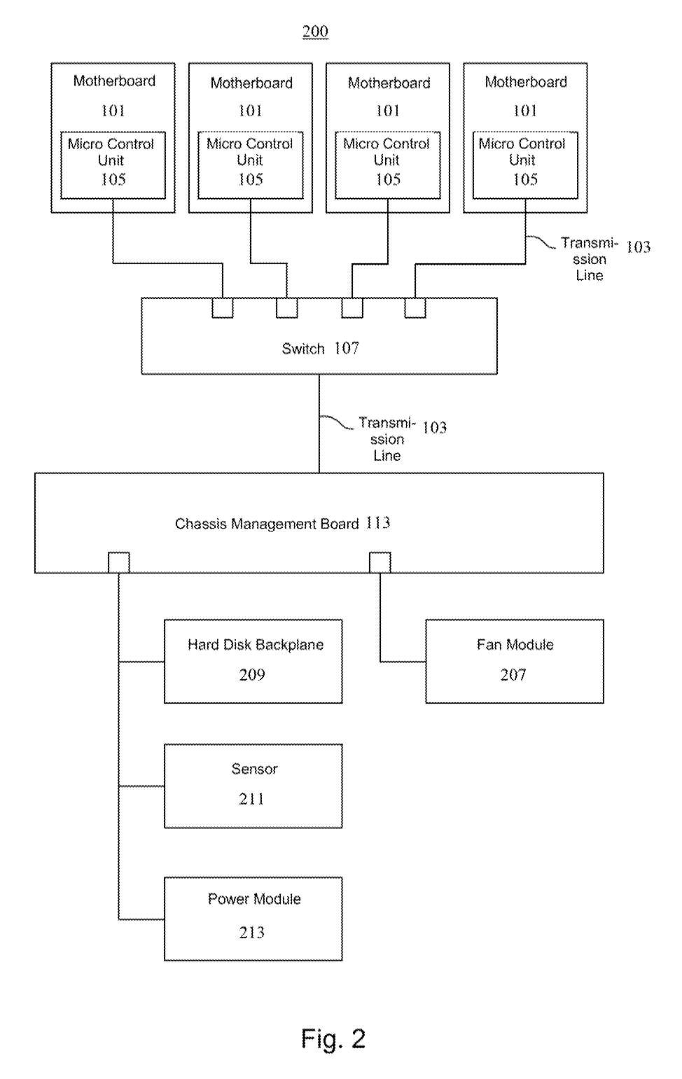

Referring to FIG. 2, FIG. 2 is a block diagram of a computer system according to another embodiment of the present invention. In this embodiment, the computer system 200 has plural motherboards 101. The motherboards 101 are not directly connected or communicated with a functional component but are connected or communicated with the functional component through the chassis management board 113, so as to simplify circuits on the computer system 200. The circuits and function of each motherboard 101 have been described in the embodiment of FIG. 1 in detail.

In this embodiment, the functional components are a fan module 207, a hard disk backplane 209, a sensor 211 and a power module 213. The power module 213 is controlled by the chassis management board 113 to provide power for the motherboard 101. For example, the chassis management board 113 can determine whether to require the power module 213 to increase or reduce the supplying power for plural motherboards 101 according to a power usage condition of the motherboards 101.

The sensor 211 is electrically connected to the chassis management board 113, and the sensor 211 is used for detecting an ambient temperature. The fan module 207 is electrically connected to the chassis management board 113, and a rotation speed of the fan module 207 is controlled by the chassis management board 113 so that the fan module 207 produces an air flow to decrease an ambient temperature. For example, if the chassis management board 113 determines that an ambient temperature detected by the sensor 211 around the computer system 200 is too high and may impair the electronic component in the computer system 200, the chassis management board 113 informs the fan module 207 to increase the rotation speed, so as to lower the temperature of the computer system 200.

The hard disk backplane 209 is connected in a switchable way between the chassis management board 113 and multiple hard disks (not shown), so that the chassis management board 113 or the motherboard 101 can control and manage the hard disks. Multiple slave micro control units can be equipped on the hard disk backplane 209 and can decode a message from a hard disk controller/a hard disk.

In the above embodiments, micro control units substitute baseboard management controllers of the original motherboard and the integrated motherboard, thereby reducing a manufacturing cost. The integrated motherboard first unifies circuits on the motherboards and then uniformly communicates with the management board, thereby simplifying circuit connections within the system, avoiding an overhigh density or excessive complexity of a circuit within the system so as not to cause a short circuit or an electromagnetic interference, and reducing the manpower for wiring.

Although the present invention has been disclosed with reference to the above embodiments, these embodiments are not intended to limit the present invention. It will be apparent to those skilled in the art that various modifications and variations can be made without departing from the scope or spirit of the present invention. Therefore, the scope of the present invention shall be defined by the appended claims.

What is claimed is:

1. A computer system, comprising:
at least one motherboard having a micro control unit;
a chassis management board; and
at least one functional component electrically connected to the chassis management board;
wherein the micro control unit processes data and passes the processed data to the chassis management board through a transmission line, wherein, after receiving and decoding the data passed from the micro control unit, the chassis management board transmits the data to the functional component, and after receiving the data returned from the functional component, the chassis management board processes the data and transmits the data to the micro control unit through the transmission line.

2. The computer system of claim 1, further comprising a switch, wherein the data is transmitted by the micro control unit to the switch and then transmitted by the switch to the chassis management board, and after receiving the data passed from the chassis management board, the switch passes the data to the corresponding motherboard.

3. The computer system of claim 2, wherein the transmission line is a network line.

4. The computer system of claim 1, wherein the functional component is a sensor, electrically connected to the chassis management board, for detecting an ambient temperature.

5. The computer system of claim 1, wherein the functional component is a power module, controlled by the chassis management board, so as to provide power for the motherboard.

6. The computer system of claim 1, wherein the functional component is a fan module, electrically connected to the chassis management board, wherein a rotation speed of the fan module is controlled by the chassis management board so that the fan module produces an air flow to decrease an ambient temperature.
